(19) United States
(12) Patent Application Publication
(10) Pub. No.: US 2015/0356143 A1
(43) Pub. Date: Dec. 10, 2015

(54) GENERATING A HINT FOR A QUERY

(71) Applicants: Limei JIAO, (US); Zhao CAO, (US); Shimin CHEN, Beijing (CN); Min WANG, (US); HEWLETT-PACKARD DEVELOPMENT COMPANY, L.P., Houston, TX (US)

(72) Inventors: Li-Mei JIAO, Beijing (CN); Zhao CAO, Beijing (CN); Shimin CHEN, Beijing (CN); Min WANG, Beijing (CN)

(21) Appl. No.: 14/763,498

(22) PCT Filed: Jan. 31, 2013
(86) PCT No.: PCT/CN2013/000106

§ 371 Date: Jul. 24, 2015

(51) Int. Cl. G06F 17/30

(52) U.S. Cl. CPC G06F 17/30507; G06F 17/30958

(57) ABSTRACT

A method, system, and non-transitory computer readable medium for generating a hint for a query are disclosed. A model which represents relevance between attributes in a dataset is constructed based on historical data associated with the dataset. According to said model, statistics about the attributes are computed. And in response to a query input by a user, a hint is generated for the query based on the model and statistics.

### BACKGROUND

In recent years, with the advancement of data collection, data scale has become very large. For example, an event log, which is a typical high dimensional data set, can have more than a hundred dimensions. An event log extracts event log data from networking and computing devices, stores the log data as a big relation table on a server or a cluster of servers, and provides a query facility for log analysis. However, massive data leads to expensive query processing time, which limits many types of applications and makes effective data analysis difficult to achieve. Some applications may desire to keep a short query response time such as data mining, decision support and analysis, while many other applications may find approximate answers adequate to provide insights about the data, at least in a preliminary phase of analysis.

### BRIEF DESCRIPTION OF THE DRAWINGS

The accompanying drawings illustrate various examples of various aspects of the present disclosure. It will be appreciated that the illustrated element boundaries (e.g., boxes, groups of boxes, or other shapes) in the figures represent one example of the boundaries. It will be appreciated that in some examples one element may be designed as multiple elements or that multiple elements may be designed as one element. In some examples, an element shown as an internal component of another element may be implemented as an external component and vice versa.

FIG. 1 is a block diagram of a system that may generate a hint for a query according to an example of the present disclosure;

FIG. 2 is a process flow diagram for a method of generating a hint for a query according to an example of the present disclosure;

FIG. 3 is a process flow diagram for another method of generating a hint for a query according to another example of the present disclosure;

FIGS. 4A-4C are schematic diagrams showing transformation of an undirected connected graph to a junction tree according to another example of the present disclosure;

FIG. 5 is a process flow diagram for another method of generating a hint for a query according to another example of the present disclosure;

FIG. 6 is a process flow diagram for a method of generating a hint for a query based on a junction tree and statistics about attributes of the hint according to an example of the present disclosure;

FIG. 7 is a process flow diagram for another method of generating a hint for a query based on a junction tree and statistics about attributes of the hint according to another example of the present disclosure;

FIG. 8 is an example of a junction tree constructed according to an example of the present disclosure;

FIG. 9 is an example of a sub-tree in the junction tree of FIG. 8; and

FIG. 10 is a block diagram showing a non-transitory, computer-readable medium that stores code for generating a hint for a query according to an example of the present disclosure.

### DETAILED DESCRIPTION

Systems and methods for generating a hint for a query on a dataset are disclosed. As used herein, a “dataset” can include rows and columns, wherein each row is also known as a record and each column contains various values of an attribute. The dataset can be static or dynamic such as an event log dataset where event log data streams in the dataset in a continuous way. As used herein, a query can be consisted of attributes, their values and operators such as AND, OR, NOT and so on. Without loss of generality, a query can be in the format of “Aᵢ₁=vᵢ₁ Ops Aᵢ₂=vᵢ₂ Ops . . . ”, wherein Aᵢⱼ is an attribute of a dataset, vᵢⱼ is the value of Aᵢⱼ and Ops represents an operator. If a user has input a new query of “A_{q1}=V_{q1} and A_{q2}=V_{q2} and . . . and A_{qk}=V_{qk}” and also specified another attribute A_{qk+1}, an example query hint is to present the user an estimated data distribution on attribute A_{qk+1} while satisfying the k prior given conditions of A_{qi}.

The following are two examples of query hints:

$$OS = “ Linux ” AND DeviceVendor = \begin{matrix}“ Sun ” \text{:} 20 \% \\ “ IBM ” \text{:} 10 \% \\ “ HP ” \text{:} 5 \% \\ …\end{matrix}$$

$$OS = “ Linux ” AND DeviceVendor = “ HP ” AND$$

$$DeviceEventClassId CONTAINS \begin{matrix}“ agent \text{:} 015 ” \text{:} 10 \% \\ “ agent \text{:} 100 ” \text{:} 10 \% \\ …\end{matrix}$$

Wherein, in the first example, a query hint presents a user the distinct values and their distributions (e.g. Sun 20%; IBM 10%; HP 5% . . . ) for specified attribute “DeviceVendor” while meeting the condition “OS=‘Linux’. The user can complete “DeviceVendor=” by choosing a value in the hints list. The above process will continue if the user inputs the third attribute “DeviceEventClassld” as shown in the second example.

An example of the present disclosure can leverage statistics techniques and graphical models to infer probabilistic distribution on any specified attribute in a dataset and present it to the user as a hint. Examples of the present disclosure may generate query hints to help users identify the interesting content from a large dataset such as the event log data and thus focus on their explorations quickly and effectively without consuming significant amounts of valuable system resources. Further, query hints generated by examples of the present disclosure may help users compose their queries, and allow them to get a preliminary understanding about the dataset and then determine whether they would like to spend more time and resources to execute the query to completion.

In the following, certain examples of the present disclosure are described in detail with reference to the drawings.

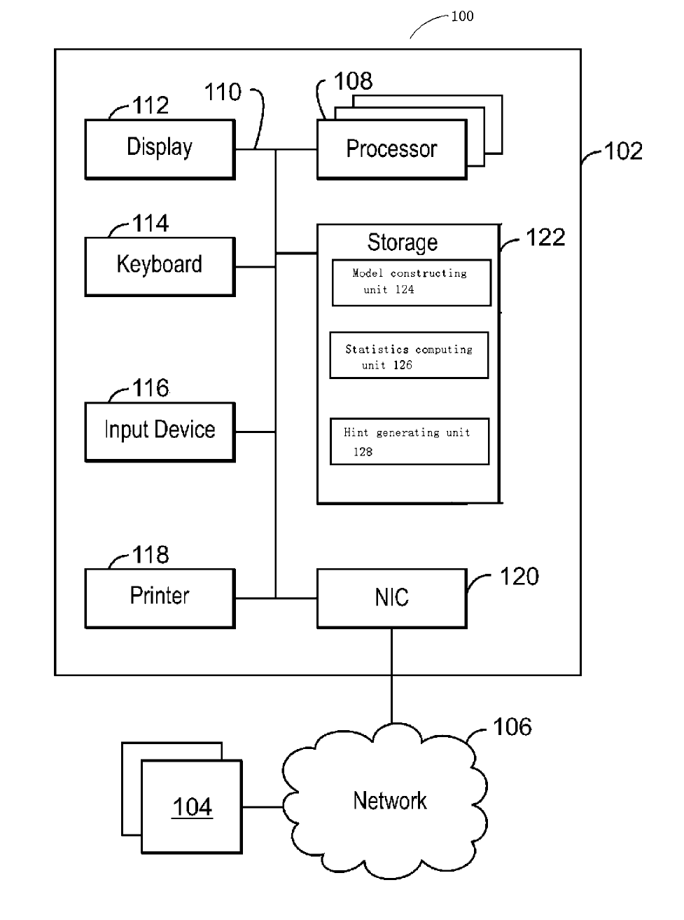

Referring now to FIG. 1, a block diagram of a system that may generate a hint for a query according to an example of the present disclosure is described. The system is generally referred to by the reference number 100. Those of ordinary skill in the art will appreciate that the functional blocks and devices shown in FIG. 1 may comprise hardware elements including circuitry, software elements including computer code stored on a tangible, machine-readable medium, or a combination of both hardware and software elements. Additionally, the functional blocks and devices of the system 100 are but one example of functional blocks and devices that may be implemented in an example. Those of ordinary skill in the art would readily be able to define specific functional blocks based on design considerations for a particular electronic device.

The system 100 may include a server 102, and one or more client computers 104, in communication over a network 106. As illustrated in FIG. 1, the server 102 may include one or more processors 108 which may be connected through a bus 110 to a display 112, a keyboard 114, one or more input devices 116, and an output device, such as a printer 118. The input devices 116 may include devices such as a mouse or touch screen. The processors 108 may include a single core, multiple cores, or a cluster of cores in a cloud computing architecture. The server 102 may also be connected through the bus 110 to a network interface card (NIC) 120. The NIC 120 may connect the server 102 to the network 106.

The network 106 may be a local area network (LAN), a wide area network (WAN), or another network configuration. The network 106 may include routers, switches, modems, or any other kind of interface device used for interconnection. The network 106 may connect to several client computers 104. Through the network 106, several client computers 104 may connect to the server 102. The client computers 104 may be similarly structured as the server 102.

The server 102 may have other units operatively coupled to the processor 108 through the bus 110. These units may include tangible, machine-readable storage media, such as storage 122. The storage 122 may include any combinations of hard drives, read-only memory (ROM), random access memory (RAM), RAM drives, flash drives, optical drives, cache memory, and the like. Storage 122 may include a model constructing unit 124, a statistics computing unit 126 and a hint generating unit 128.

The model constructing unit 124 may be used to construct a model which represents relevance between attributes in a dataset on which a query is to be run, based on historical data associated with the dataset. The historical data can include query historical data (i.e., queries submitted by users previously) and dataset historical data (i.e., data that is collected before a new query is submitted). The statistics computing unit 126 may be used to compute statistics about attributes according to the model constructed by the model constructing unit 124. The hint generating unit 128 may be used to generate, in response to a query input by a user, a hint for said query based on the model constructed by the model constructing unit 124 and the statistics computed by the statistics computing unit 126.

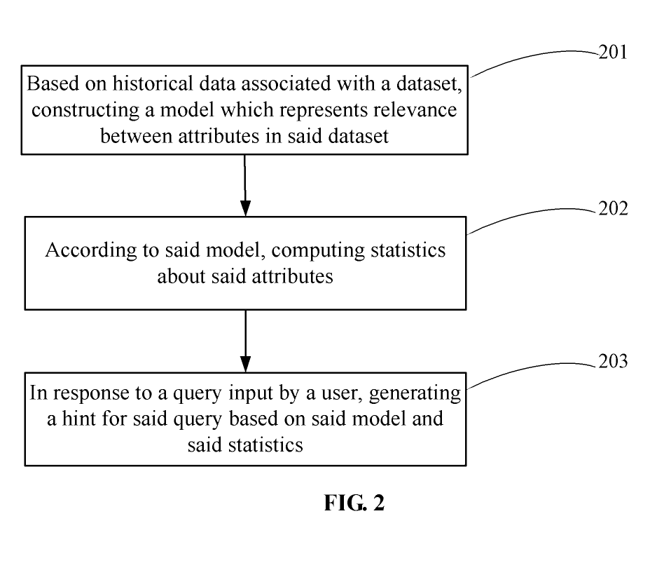

With reference to FIG. 2 now, FIG. 2 is a process flow diagram for a method of generating a hint for a query according to an example of the present disclosure. At block 201, based on historical data associated with a dataset, a model is constructed which represents relevance between attributes in said dataset. As described above, the historical data can include query historical data and dataset historical data. At block 202, statistics are computed about these attributes according to said model. At block 203, in response to a query input by a user, a hint for said query is generated based on said model and said statistics.

According to an example of the present disclosure, the model constructed at block 201 can be a junction tree. A node of the junction tree represents a set of attributes that are determined to be relevant and an edge of the junction tree represents a common attribute between two nodes connected by said edge.

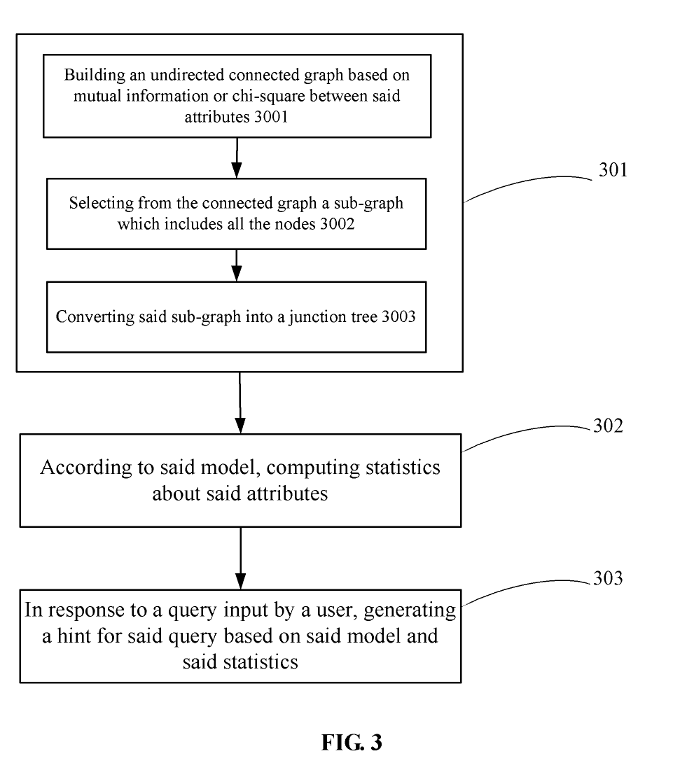

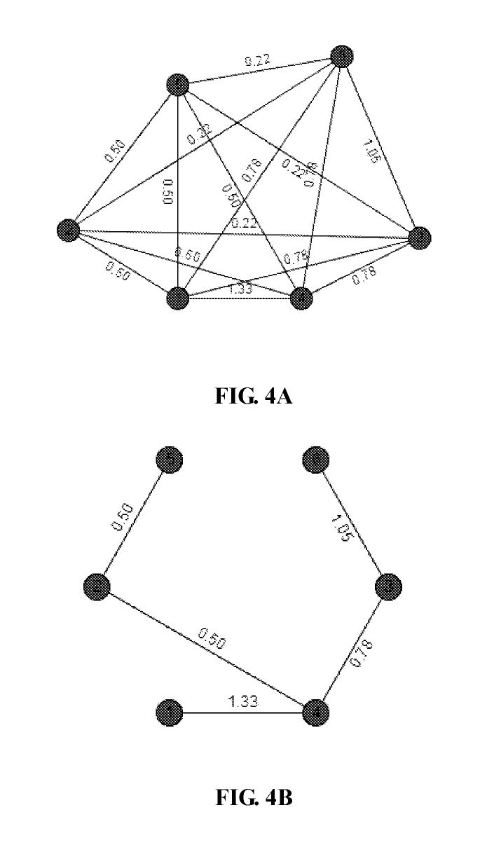

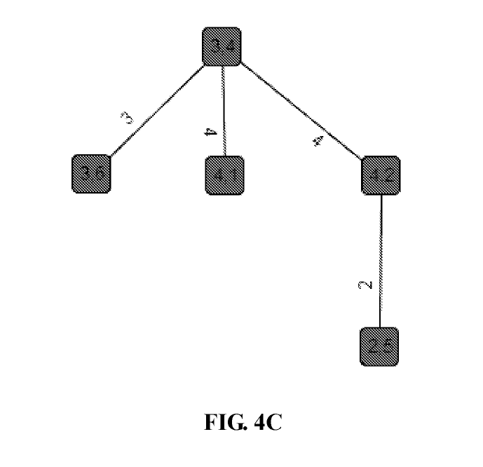

With reference to FIG. 3 now, FIG. 3 is a process flow diagram for another method of generating a hint for a query according to another example of the present disclosure. As shown in FIG. 3, blocks 302 and 303 are the same as blocks 202 and 203 and will not be described in detailed herein. Block 301 is an example implementation of how to construct a model such as a junction tree. Specifically, at block 3001, an undirected connected graph is built based on mutual information or chi-square between attributes in the dataset, wherein a node of the undirected connected graph represents an attribute and an edge between any two nodes in the connected graph represents said mutual information or chi-square. FIG. 4A shows an example of an undirected connected graph, wherein nodes 1-6 represent different attributes in a dataset and the weight of an edge is the mutual information of the two attributes. At block 3002, a sub-graph can be selected from the connected graph which includes all the nodes in the graph. FIG. 4B shows a sub-graph selected from the connected graph in FIG. 4A, which covers all the nodes 1-6.

Several strategies can be considered for selecting a sub-graph from an undirected connected graph: (1) Maximum spanning tree—it is a spanning tree of a weighted graph having maximum weight. (2) Minimum diameter of the final sub-graph—it is a spanning tree having the minimum diameter. (3) Minimum estimation error computed using the previous actual query workload—it is a spanning tree achieving minimum estimation error for previous queries. This process can be an offline computation. Then, at block 3003, the sub-graph is converted into a junction tree. During converting, the nodes in the sub-graph are first clustered into groups. This involves choosing a node ordering of the sub-graph and using node elimination to identify a set of clusters, wherein each cluster includes attributes that are deemed to be relevant in the dataset according to, for example, the mutual information. Then, a junction tree as shown in FIG. 4C is built up by creating nodes corresponding to the clusters and inserting the appropriate separators between them, wherein each separator represents a common attribute between the two nodes connected by the separator.

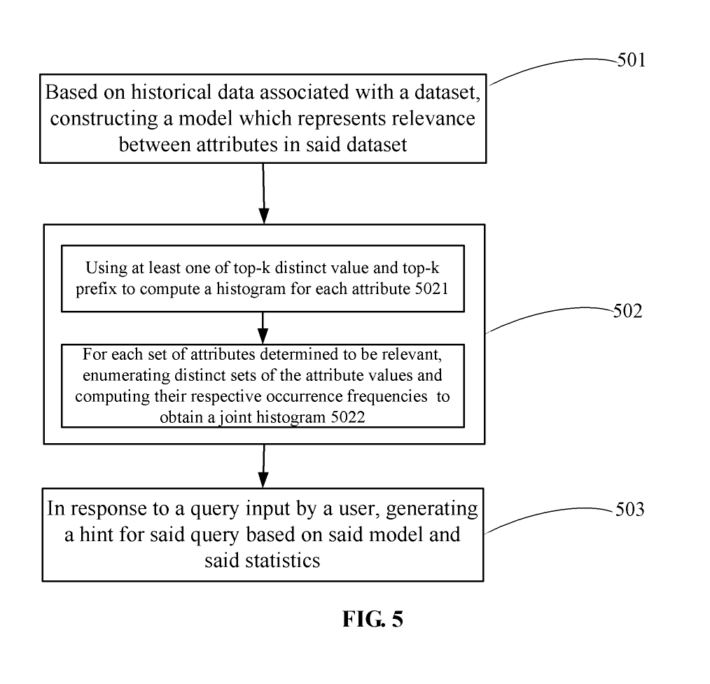

With reference to FIG. 5 now, FIG. 5 is a process flow diagram for another method of generating a hint for a query according to another example of the present disclosure. As shown in FIG. 5, blocks 501 and 503 are the same as blocks 201 and 203 in FIG. 2 and will not be described in detailed herein. Block 502 is an example implementation of how to compute statistics about attributes in the dataset based on the model constructed at block 201 such as a junction tree. According to an example of the present disclosure, the statistics can include a histogram for each of the attributes and a joint histogram for each set of attributes that are determined to be relevant in said model. For example, continuing with the example given in FIGS. 4A-C, the statistics can include a 1D histogram for each of attributes 1-6 and also include 2D histograms for the attribute set {(3,4), (3,6), (4,1), (4,2) and (2,5)}, i.e., attribute sets contained in each node of the junction tree. As known, a 1D histogram for an attribute can include the values of the attribute and their respective occurrence frequencies in the dataset. A 2D histogram can include different combinations of two attributes and their respective occurrence frequencies in the dataset. It is appreciated that, although FIG. 4C only shows nodes in a junction tree that each include two attributes, it will be understood that three or more attributes can be included in each node and the present disclosure is not limited in this regard.

According to an example of the present disclosure, as new log data flows into the dataset continuously, computing the statistics of the attributes can be performed in a real-time manner.

In an example, computing a histogram for an attribute can include using at least one of top-k distinct value and top-k prefix to compute the histogram based on data type in the dataset, as shown in block 5021. A top-k distinct value histogram refers to a histogram that keeps the most frequent k distinct values and their corresponding frequencies and a top-k distinct value refers to a value that is one of the most frequent k distinct values. A top-k prefix histogram can be used if there are a large number of distinct values with similar frequencies and thus it is very difficult to keep all the values given the efficiency requirement and space budget. In a top-k prefix histogram, all the string values of an attribute can be represented in a tree, where a value is represented as a labeled path from the root of the tree to a leaf node of the tree and every non-leaf node in the tree represents a prefix of all the strings in the subtrees or children of this non-leaf node. In a top-k prefix histogram, a weight can be assigned to every node (including both leaf nodes and non-leaf nodes) and then top-k prefixes are identified in the tree, as described in detail below.

For an attribute with a few distinct values, a top-k distinct value histogram can be computed. In this histogram construction, an empty bucket with k entries can be built in advance and then the distinct values and their frequencies are inserted into the bucket as the data comes. After the bucket is full, if a new incoming data equals to one entry of the bucket, then the corresponding frequency is added by 1. If the new data doesn't equal to any entry, then for purposes of saving storage space, a hashing operation can be performed on the new data to obtain a hash item. If the hash item is new, then it is put into a hash table as a new item. Otherwise, if the hash item already exists in the hash table, the existing item is added by 1. The frequency of the existing item is compared with the minimum frequency of the bucket. If the frequency of the existing item is greater, then the minimum distinct value in the bucket and this existing item in the hash table are replaced with each other.

If there are too many distinct values for an attribute or if the space is not enough to store the frequency table, a method of top-k prefix can be used to construct a 1D histogram for the attribute. As mentioned above, in the top-k prefix histogram, a weight is assigned to every node. For example, the weight of a node b can be defined by the following equation:

$${w}_{b } = {\sum }_{1 \leq i \leq n} \frac{\vert {p}_{b} \vert}{\vert {p}_{i} \vert} freq ( {l}_{i} )$$

Wherein, Iᵢ is a child string which is covered by node b; freq(Iᵢ) is the frequency of Iᵢ appearing in the data set; p_{b} and pᵢ are the length of node b and node Iᵢ respectively and n is the children number of node b. Then, nodes with the greatest weights can be selected in the tree as top-k prefixes.

In an example, since the amount of 2D and 3D or higher dimensional histograms has been highly reduced in the phase of junction tree building, computing a joint histogram for each set of attributes in a node of the junction tree can include enumerating distinct sets of attribute values and computing their respective occurrence frequencies, as shown in block 5022.

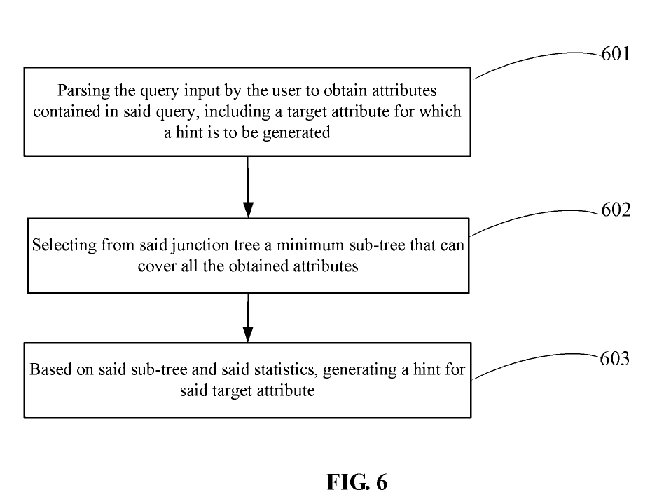

With reference to FIG. 6 now, FIG. 6 is a process flow diagram for a method of generating a hint for a query based on a junction tree and statistics about attributes of the hint according to an example of the present disclosure. The process shown in FIG. 6 is an example method of implementing block 203 in FIG. 2. At block 601, the query input by the user is parsed to obtain attributes contained in the query, wherein the obtained attributes include a target attribute for which a hint is to be generated. For example, in the second example given above, the obtained attributes include “Linux”, “DeviceVendor” and “DeviceEventClassId”, wherein “DeviceEventClassId” is the target attribute for which a hint is to be generated.

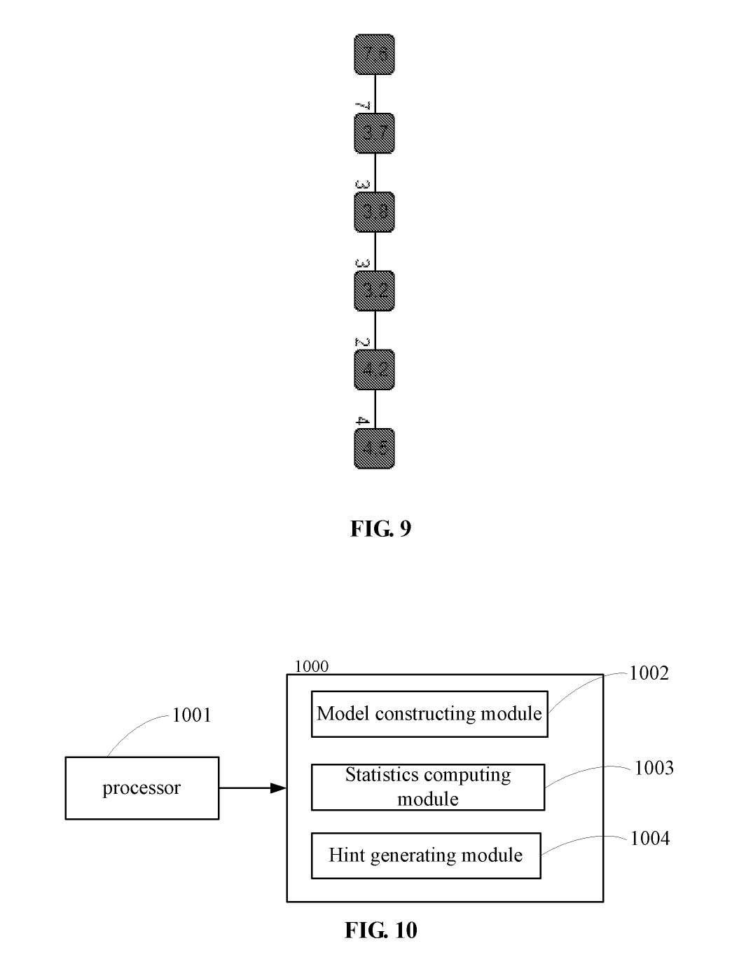

At block 602, a minimum sub-tree that can cover all the obtained attributes may be selected from a junction tree constructed for example at block 201. For example, FIG. 8 shows a junction tree for a real web log dataset that is constructed according to an example of the present disclosure, wherein attribute 1 (i.e. A1) represents a time stamp, A2 represents a time span, A3 represents customer IP, A4 represents a Hit/Miss in cache, A5 represents a Domain of page, A6 represents a data type, A7 represents a Referral URL, and A8 represents a Browser. information. FIG. 9 shows an example of a sub-tree selected from the junction tree in FIG. 8 and this sub-tree is directed to a query of A4=“TCP_MISS/200” and “A5=“DIRECT/202.108.33.107” and A2=“21” and A6=, with A6being the target attribute.

At block 603, a hint is generated for the target attribute based on the sub-tree selected at block 602 and the statistics computed for example at block 202.

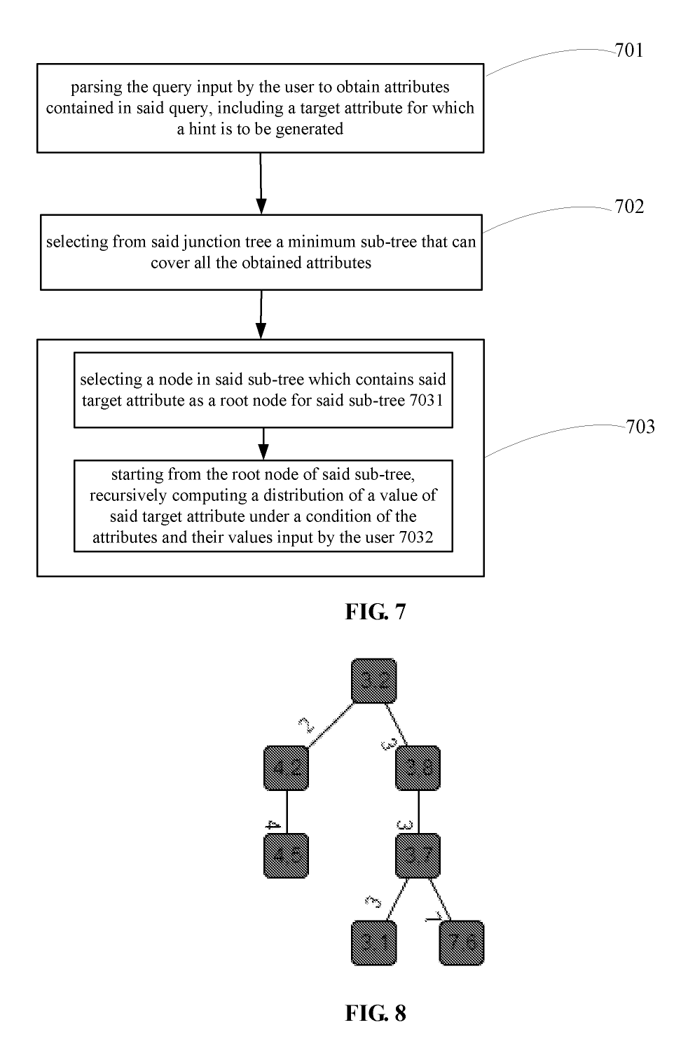

With reference to FIG. 7 now, FIG. 7 is a process flow diagram for another method of generating a hint for a query based on a junction tree and statistics about attributes of the hint according to another example of the present disclosure. Blocks 701 and 702 are the same as blocks 601 and 602 and will not be described herein in detail. At block 7031, after a minimum sub-tree that can cover all the obtained attributes in a query is selected, a node in the sub-tree which contains the target attribute is selected as a root node for the sub-tree. Continuing with the above example, the node (7,6) will be selected as the root node. At block 7032, starting from the root node of the sub-tree, a distribution of a value of the target attribute (e.g. A6) is recursively computed under a condition of the attributes and their values input by the user, (e.g. satisfying the condition of A4=“TCP_MISS/200” and “A5=“DIRECT/202.108.33.107” and A2=“21”).

The following is an example algorithm for calculating the distribution of the target attribute.

Algorithm computeDist(JTNode root, Set<Filter> atts, Set<Filter> keep)

```
if atts ⊂ root.mstNodes then
  return project(root.dist, atts, keep)
else
  diff = atts − root.mstNodes
  H = root.dist
  for each child Cᵢ of root do
    S = root.mstNodes ∩ Cᵢ.mstNodes
    h = computeDist(Cᵢ, diff ∪ S, keep ∪ S)
    H = product(H, h, S)
  end for
  return project(H, atts, keep)
end if
```

The principle for computing the distribution in the above algorithm is that for a junction tree (A,B)-B-(B,C) with (A,B) and (B,C) being nodes and B being an edge connecting them, the joint probability distribution of P(A,C) is calculated as P(A,C)=P(A,B)*P(B,C)/P(B).

In this algorithm, the function computDist has three arguments, wherein root is the junction tree node where the propagation starts from; atts is the attribute-value pair set who have been assigned values and the attribute that is searched for; keep is the attribute set whose joint distribution is desired; dist represents distribution; mstnodes are attributes contained in a node; project is function to perform projection operation based on atts and keep; and product is a function to compute H*h/distribution of S. This algorithm is a recursive one. If the root contains all the attributes, the projection results are returned based on the keep attribute and filter condition in atts. Otherwise, for each child of the root node, the atts and keep arguments are first calculated and then the joint distribution of attributes in keep are determined. Finally the result of each node is multiplied according to properties of the junction tree.

For example, suppose that attributes in a dataset are A, B, C and D and the query input by a user is “A=a” and D, and the sub-tree selected from a junction tree is (C,D)-C-(B,C)-B-(A,B). Then, in the first nest loop, root=(C,D), atts=[A D], and keep=D. In the second nest loop, root=(B,C), atts=[A C], and keep=[C D]. In the third and final nest loop, root=(A,B), atts=[A B], and keep=[B C D].

The above algorithm is just an example of computing a distribution for an attribute and other methods can be conceived in light of the present disclosure.

With reference to FIG. 10 now, FIG. 10 is a block diagram showing a non-transitory, computer-readable medium that stores code for generating a hint for a query according to an example of the present disclosure. The non-transitory, computer-readable medium is generally referred to by the reference number 1000.

The non-transitory, computer-readable medium 1000 may correspond to any typical storage device that stores computer-implemented instructions, such as programming code or the like. For example, the non-transitory, computer-readable medium 1000 may include one or more of a non-volatile memory, a volatile memory, and/or one or more storage devices. Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disks, compact disc drives, digital versatile disc drives, and flash memory devices.

A processor 1001 generally retrieves and executes the computer-implemented instructions stored in the non-transitory, computer-readable medium 1000 for generating a hint for a query. At block 1002, a model constructing module may construct a model which represents relevance between attributes in a dataset based on historical data associated with the dataset. At block 1003, a statistics computing module may compute statistics about said attributes according to the model constructed by the model constructing module 1002. At block 1004, in response to a query input by a user, a hint generating module may generate a hint for said query based on the model and the statistics.

Examples of the present disclosure can provide a practical and user friendly query hints implementation, which helps users organize their queries and get wanted insights into real data quickly. Advantageously, query hints can be applied in many circumstances, e.g., from event log management applications, such as security management, IT trouble shooting, to user behavior analysis. Examples of the present disclosure can also support high dimensional data estimation by combining data-driven and query-driven methods for automatic discovery of correlations. Based on attributes correlations, a simplistic and scalable graphic model can be used for probability distribution propagation. Examples of the present disclosure also achieve high space and time efficiency.

From the above depiction of the implementation mode, the above examples can be implemented by hardware, software or firmware or a combination thereof. For example, the various methods, processes, modules and functional units described herein may be implemented by a processor (the term processor is to be interpreted broadly to include a CPU, processing unit, ASIC, logic unit, or programmable gate array etc.) The processes, methods and functional units may all be performed by a single processor or be split between several processers. They may be implemented as machine readable instructions executable by one or more processors. Further the teachings herein may be implemented in the form of a software product. The computer software product is stored in a storage medium and comprises a plurality of instructions for making a computer device (which can be a personal computer, a server or a network device, etc.) implement the method recited in the examples of the present disclosure.

The figures are only illustrations of an example, wherein the modules or procedure shown in the figures are not necessarily essential for implementing the present disclosure. Moreover, the sequence numbers of the above examples are only for description, and do not indicate an example is more superior to another.

Those skilled in the art can understand that the modules in the device in the example can be arranged in the device in the example as described in the example, or can be alternatively located in one or more devices different from that in the example. The modules in the aforesaid example can be combined into one module or further divided into a plurality of sub-modules.

What is claimed is:

1. A method for generating a hint for a query, comprising:
based on historical data associated with a dataset, constructing a model which represents relevance between attributes in said dataset;
according to said model, computing statistics about said attributes; and
in response to a query input by a user, generating a hint for said query based on said model and said statistics.

2. The method of claim 1, wherein said model is a junction tree and wherein a node of said junction tree represents a set of attributes that are determined to be relevant and an edge of said junction tree represents a common attribute between two nodes connected by said edge.

3. The method of claim 2, wherein constructing a model which represents relevance between attributes based on historical data further comprises:
building an undirected connected graph based on mutual information or chi-square between said attributes, wherein a node of said undirected connected graph represents an attribute and an edge between any two nodes in said connected graph represents said mutual information or chi-square;
selecting from said connected graph a sub-graph which includes all the nodes in the junction tree; and
converting said sub-graph into said junction tree.

4. The method of claim 1, wherein said statistics include a histogram for each of said attributes and a joint histogram for each set of attributes that are determined to be relevant in said model.

5. The method of claim 4, wherein computing a histogram for each attribute further includes using at least one of top-k distinct value and top-k prefix to compute said histogram based on a data type in the dataset.

6. The method of claim 4, wherein computing a joint histogram for each set of attributes further includes enumerating distinct sets of attribute values and computing their respective occurrence frequencies.

7. The method of claim 2, wherein generating a hint for said query based on said model and said statistics further comprises:
parsing the query input by the user to obtain attributes contained in said query, including a target attribute for which a hint is to be generated;
selecting from said junction tree a minimum sub-tree that can cover all the obtained attributes; and
based on said sub-tree and said statistics, generating a hint for said target attribute.

8. The method of claim 7, wherein generating a hint for said target attribute based on said sub-tree and said statistics further comprises:
selecting a node in said sub-tree which contains said target attribute as a root node for said sub-tree; and
starting from the root node of said sub-tree, recursively computing a distribution of a value of said target attribute under a condition of the attributes and their values input by the user.

9. A system for generating a hint for a query, the system comprising:
a processor that is adapted to execute stored instructions; and
a memory device that stores instructions, the memory device comprising processor-executable code, that when executed by the processor, is adapted to:
based on historical data associated with a dataset, construct a model which represents relevance between attributes in said dataset;
according to said model, compute statistics about said attributes; and
in response to a query input by a user, generate a hint for said query based on said model and said statistics.

10. The system of claim 9, wherein said model is a junction tree and wherein a node of said junction tree represents a set of attributes that are determined to be relevant and an edge of said junction tree represents a common attribute between two nodes connected by said edge.

11. The system of claim 10, wherein the memory stores processor-executable code adapted to construct a model which represents relevance between attributes based on historical data by:
building an undirected connected graph based on mutual information or chi-square between said attributes, wherein a node of said undirected connected graph represents an attribute and an edge between any two nodes in said connected graph represents said mutual information or chi-square;
selecting from said connected graph a sub-graph which includes all the nodes of the junction tree; and
converting said sub-graph into said junction tree.

12. The system of claim 10, wherein the memory stores processor-executable code adapted to generate a hint for said query based on said model and said statistics by:
parsing the query input by the user to obtain attributes contained in said query, including a target attribute for which a hint is to be generated;
selecting from said junction tree a minimum sub-tree that can cover all the obtained attributes; and
based on said sub-tree and said statistics, generating a hint for said target attribute.

13. A non-transitory, computer-readable medium comprising code configured to direct a processor to:
based on historical data associated with a dataset, construct a model which represents relevance between attributes in said dataset;
according to said model, compute statistics about said attributes; and
in response to a query input by a user, generate a hint for said query based on said model and said statistics.

14. The system of claim 13, wherein said model is a junction tree and wherein a node of said junction tree represents a set of attributes that are determined to be relevant and an edge of said junction tree represents a common attribute between two nodes connected by said edge.

15. The system of claim 14, wherein the non-transitory, computer-readable medium comprises code configured to generate a hint for said query based on said model and said statistics by:
parsing the query input by the user to obtain attributes contained in said query, including a target attribute for which a hint is to be generated;
selecting from said junction tree a minimum sub-tree that can cover all the obtained attributes; and
based on said sub-tree and said statistics, generating a hint for said target attribute.
